(19) United States
(12) Patent Application Publication
(10) Pub. No.: US 2017/0336899 A1
(43) Pub. Date: Nov. 23, 2017

(54) ELECTRONIC DEVICE WITH TOUCH SENSITIVE, PRESSURE SENSITIVE AND DISPLAYABLE SIDES

(71) Applicant: Timothy Jing Yin SZETO, Mississauga (CA)

(72) Inventor: Timothy Jing Yin SZETO, Mississauga (CA)

(21) Appl. No.: 15/522,365

(22) PCT Filed: Oct. 30, 2015
(86) PCT No.: PCT/CA2015/051110

§ 371 Date: Apr. 27, 2017

Related U.S. Application Data
(60) Provisional application No. 62/072,492, filed on Oct. 30, 2014.

(51) Int. Cl. G06F 3/041; G06F 3/0481; G06F 1/16; G06F 3/0488

(52) U.S. Cl. CPC G06F 3/0414; G06F 3/04883; G06F 3/0481; G06F 1/1692; G06F 2203/04104; G06F 2203/04106

(57) ABSTRACT

An electronic device is disclosed that includes a body having an external surface; a processor enclosed within the body; and at least one force sensor disposed on the body and connected to the processor, the force sensor being operable to generate at least one signal indicative of a magnitude of a force applied to the external surface of the body, the processor being configured to receive the at least one signal and to determine a user input by processing the received at least one signal. The device may include at least one touch sensing surface and may be operable to receive a touch applied to the external surface of the body and to generate at least one signal indicative of a location of the received touch on the at least one touch sensing surface.

### REFERENCE TO RELATED APPLICATION

This patent application claims priority of U.S. provisional Application Ser. No. 62/072,492, filed on Oct. 30, 2014, the content of which is hereby incorporated by reference.

### TECHNICAL FIELD

This disclosure relates generally to electronic devices, and more particularly to electronic devices having pressure sensitive user interfaces.

### BACKGROUND

Conventional electronic devices such as mobile phones or tablet computers typically have a user interface that includes a plurality of mechanical inputs in addition to any graphical user interface. For example, a device's user interface may include a power button, volume buttons, a home button, and a camera button.

Typically, such buttons are disposed at fixed locations and have fixed functions. This may restrict the ways in which users may access the buttons and interact with the electronic device. Further, such buttons may restrict how the electronic device interfaces with other devices, e.g., cases, holsters, peripherals, or interconnected electronic devices. For example, cases for the electronic devices may need to be configured to expose the buttons. Peripherals such as keyboards or battery packs may need to be configured to expose the buttons or otherwise avoid the buttons, e.g., when such buttons protrude from the surface of the electronic device.

Accordingly, there is need for improved electronic devices and user interfaces for electronic devices that address one or more shortcomings of conventional electronic devices.

### SUMMARY

In an aspect, there is provided an electronic device. The electronic device may include a body having a front face, a back face and sides, a processor enclosed within the body, and at least one force sensor disposed on at least one of the sides of the body and connected to the processor. The force sensor may be operable to generate at least one signal indicative of a magnitude of a force applied to the side of the body. The processor may be configured to receive the at least one signal and to determine a user input by processing the received at least one signal.

The electronic device may include at least one force sensor which extends along a given surface of the body and may be operable to further generate at least one signal indicative of a location of the force applied to the side(s) of the body and on the given surface of the body.

The at least one force sensor may be disposed along at least part of each of two opposing sides of the sides of the electronic device.

The electronic device may also include at least one touch sensing surface which is disposed on the body and connected to the processor. The at least one touch sensing surface may be operable to receive a touch applied to the at least one of the sides of the body and to generate at least one signal indicative of a location of the received touch on the at least one touch sensing surface.

The at least one force sensor and the at least one touch sensing surface may extend along a corresponding surface of the electronic device. The at least one touch sensing surface may cover the at least one force sensor of the electronic device. The electronic device may also include a touch-sensitive screen that comprises the at least one touch sensing surface.

The determination of the user input may include processing the at least one signal received from the at least one force sensor and the at least one signal received from the at least one touch sensor.

The processor may be configured to receive, from the at least one force sensor, at least one signal indicative of a plurality of magnitudes of forces applied on the at least one of the sides of the body, each of the magnitudes associated with one of a plurality of locations of the forces.

The processor may also include a display. The display may be configured to present a visual indicator in response to receiving the at least one signal. The visual indicator may be displayed proximate the location of the force applied to the at least one of the sides of the body.

The electronic device may be a hand-held electronic device. The electronic device may be a mobile phone, a tablet computer, a laptop computer, a personal digital assistant, a camera, an e-book reader and/or a game controller.

In another aspect, there is provided a method of receiving a user input using an electronic device. The method includes receiving at least one signal from a force sensor indicative of a magnitude of a force applied to at least one side of the electronic device; and determining the user input by processing the at least one signal using a processor.

The step of receiving may include receiving at least one signal indicative of a plurality of magnitudes of forces applied successively along the at least one side of the electronic device, each of the magnitudes being associated with one of a plurality of locations distributed along the at least one side of the electronic device, and the step of determining may include determining a scroll gesture input by processing the at least one signal.

The step of receiving may include receiving at least one signal indicative of at least a first magnitude of a first force and a second magnitude of a second force, the first and second forces being applied to a respective one of two opposing sides of the electronic device, each of the at least the first magnitude and the second magnitude being associated with a respective one of first and second locations of the first and second forces. The step of determining the user input may include determining a pinch gesture input by processing the at least one signal. The at least one signal is also indicative of a plurality of magnitudes of forces applied to a respective one of the two opposing sides of the electronic device, wherein said step of determining the user input may include determining a grip gesture input by processing the at least one signal. The method may include a step of activating a fingerprint sensor located at one of the first and second locations in response to the determined pinch gesture input.

The step of receiving may include receiving at least one signal indicative of a plurality of magnitudes of forces applied across the at least one side of the electronic device, each of the magnitudes being associated with one of a plurality of locations distributed across the at least one side of the electronic device. The step of determining the user input may include determining a flick gesture input by processing the at least one signal. The step of determining the flick gesture input may include determining that at least one of the plurality of magnitudes of forces reaches a force threshold at a location surrounding the at least one side of the electronic device.

The electronic device may display a user interface element on a display surface of the electronic device. Accordingly, the method may include modifying the display of the user interface element on the display surface in response to the at least one force signal. The step of modifying may include moving the display of the user interface element along the display surface.

The display surface may have a front portion and at least two side portions. The front portion of the display surface may cover the front face of the electronic display. The two side portions of the display surface may cover a respective one of two sides of the electronic device. The step of moving may include moving the display of the user interface element from one of the two side portions towards the front portion of the display surface of the electronic device. The user interface element may be a button, such that the step of modifying may include displaying the user interface element in a depressed configuration.

In this respect, before explaining at least one embodiment in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments are illustrated by way of example. It is to be expressly understood that the description and drawings are only for the purpose of illustration and as an aid to understanding and are not intended as a definition of the limits of the invention.

Embodiments will now be described, by way of example only, with reference to the attached figures, wherein:

FIG. 1 is a perspective view of an electronic device, exemplary of an embodiment;

FIG. 2A and FIG. 2B are left and right side elevation views, respectively, of the electronic device of FIG. 1;

FIG. 3A is an exploded perspective of parts of the electronic device of FIG. 1, exemplary of an embodiment;

FIG. 3B is a top exploded view of parts of the electronic device of FIG. 1, exemplary of an embodiment;

FIG. 4 is a high-level block diagram showing computer components of the electronic device of FIG. 1, exemplary of an embodiment;

FIG. 5 is a high-level block diagram showing software components of the electronic device of FIG. 1, exemplary of an embodiment;

FIG. 6 is a schematic diagram showing mapping of touch inputs and pressure inputs for the electronic device of FIG. 1, exemplary of an embodiment;

FIG. 7 is a schematic diagram showing mapping of touch inputs and pressure inputs for the electronic device of FIG. 1 when gripped by a user, exemplary of an embodiment;

FIG. 8A and FIG. 8B show example pressure inputs received for the grip of FIG. 7;

FIG. 9 shows example touch input received for the grip of FIG. 7;

FIG. 10A and FIG. 10B are schematic diagrams of the electronic device of FIG. 1 when held by a user performing, respectively, first and second steps of a scroll gesture, exemplary of an embodiment;

FIG. 11 is a schematic diagram showing example pressure input received for the first and second steps of the scroll gesture of FIG. 10A and FIG. 10B, exemplary of an embodiment;

FIG. 12 is a schematic diagram of the electronic device of FIG. 1 when held by a user performing a pinch gesture, exemplary of an embodiment;

FIG. 13A and FIG. 13B are schematic diagrams showing example pressure inputs received for the pinch gesture of FIG. 12, exemplary of an embodiment;

FIG. 14A is a schematic diagram showing mapping of touch inputs and pressure inputs for an electronic device having a fingerprint sensor, exemplary of an embodiment;

FIG. 14B is a side elevation view of the electronic device of FIG. 14A;

FIG. 15 is a side elevation view of an electronic device having a fingerprint sensor, exemplary of a second embodiment;

FIG. 16A and FIG. 16B are front and side elevation schematic views showing the display of a user interface element when no force is applied on the electronic device of FIG. 1, exemplary of an embodiment;

FIG. 17A and FIG. 17B are front and side elevation schematic views showing the display of the user interface element of FIG. 16A and FIG. 16B when a first force is applied to the electronic device of FIG. 1, exemplary of an embodiment;

FIG. 17C is a schematic diagram showing an exemplary mapping of a pressure input in response to the first force of FIG. 17A and FIG. 17B;

FIG. 18A and FIG. 18B are front and side elevation schematic views showing the display of the user interface element of FIG. 16A and FIG. 16B when a second force is applied on the electronic device of FIG. 1, exemplary of an embodiment;

FIG. 18C is a schematic diagram showing an exemplary mapping of a pressure input in response to the second force of FIG. 18A and FIG. 18B;

FIG. 19A, FIG. 19B and FIG. 19C are schematic views showing the electronic device of FIG. 1 when gripped by a user performing, respectively, a first, a second and a third step of a flick gesture, exemplary of an embodiment;

FIG. 20 is a schematic, partial and top elevation view of the electronic device of FIG. 1 showing the user's thumb while performing the flick gesture as shown in FIG. 19A, FIG. 19B and FIG. 19C; and

FIG. 21 is a schematic diagram showing mapping of a pressure input in response to the flick gesture shown in FIG. 19A, FIG. 19B and FIG. 19C.

### DETAILED DESCRIPTION

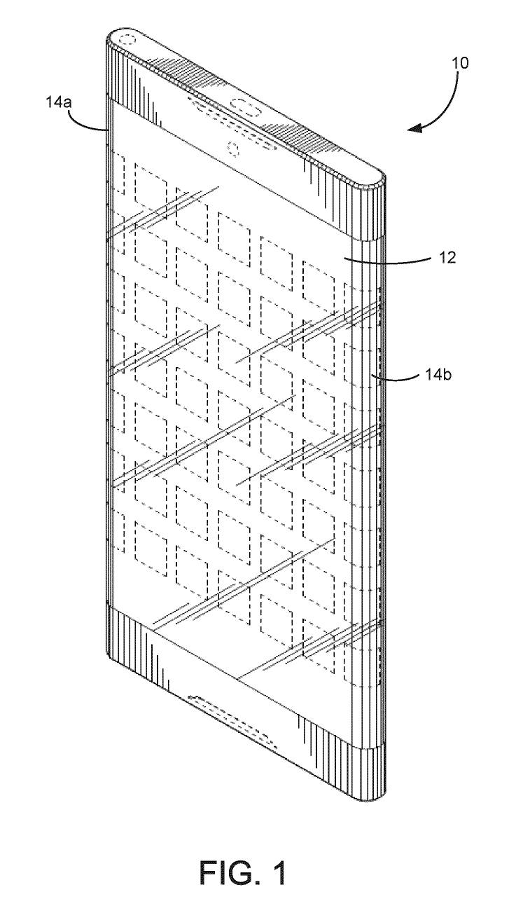

FIG. 1 illustrates an electronic device 10, exemplary of an embodiment. Electronic device 10 includes a left pressure-sensitive side 14a and a right pressure-sensitive side 14b. As will be detailed herein, each of left and right pressure-sensitive sides 14a and 14b may be formed by disposing force sensors in device 10 (e.g., along the length of sides 14a and 14b) that sense a force, corresponding to a pressure, applied by a user at particular locations on sides 14a and 14b.

As will be detailed herein, a large variety of user inputs may be determined from signals provided by these force sensors, including, e.g., pressing with a finger/thumb, squeezing the device (with a hand), pinching the device (with a finger and a thumb), sliding a finger/thumb along the device, etc. User inputs may include combinations of these and other inputs.

Electronic device 10 also includes a screen 12. Screen 12 may be configured to present a graphical user interface of device 10. As will be detailed herein, screen 12 may also be configured to provide visual cues to a user to prompt pressure input at particular locations of sides 14a and 14b or to provide visual feedback in response to pressure input.

Screen 12 may be a touch sensitive screen that includes one or more touch sensors that sense a user's touch at particular locations on the screen.

In some embodiments, device 10 may be configured to determine user input from force signals provided by the above-mentioned force sensors, touch signals provided by the touch sensors or a combination of force and touch signals.

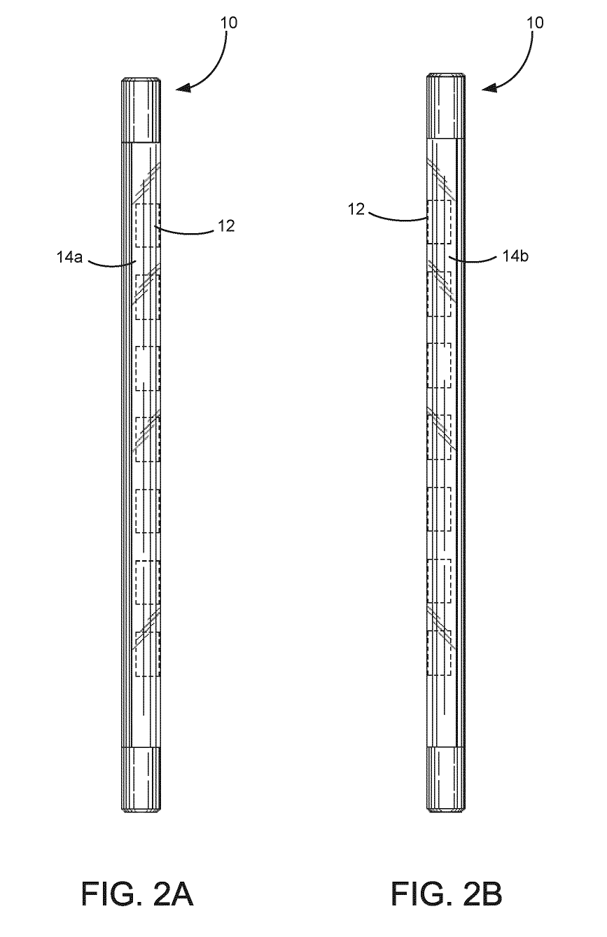

As best seen in FIG. 2A and FIG. 2B, screen 12 of device 10 extends to left and right edges of device 10 and curves at these edges to extend onto sides 14a and 14b. The displayable area of screen 12 extends onto each of these sides such that displayed elements (e.g., icons shown in dotted lines) are visible on sides 14a and 14b. This allows the above-noted visual cues to be displayed on sides 14a and 14b.

In another embodiment, screen 12 may be flat such that it extends substantially to the left and right edges of device 10 but does not extend onto sides 14a or 14b. In such cases, the above-noted visual cues may be displayed on screen 12 proximate sides 14a and 14b. In yet another embodiment, screen 12 may extend to cover all of sides 14a and 14b.

In the depicted embodiments, electronic device 10 is a mobile phone. However, in other embodiments, electronic device 10 may be another type of handheld device such as a tablet computer, a laptop computer, a personal digital assistant, a camera, an e-book reader, a game controller, or the like. In yet other embodiments, electronic device 10 may be a non-handheld device such as a consumer appliance or may be part of another device, e.g., a vehicle.

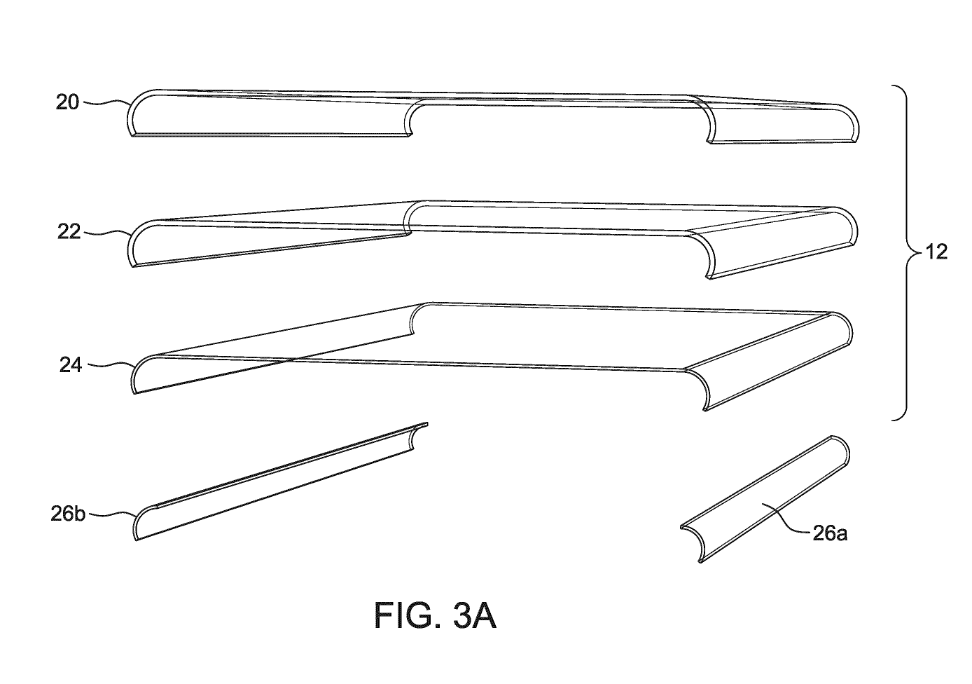

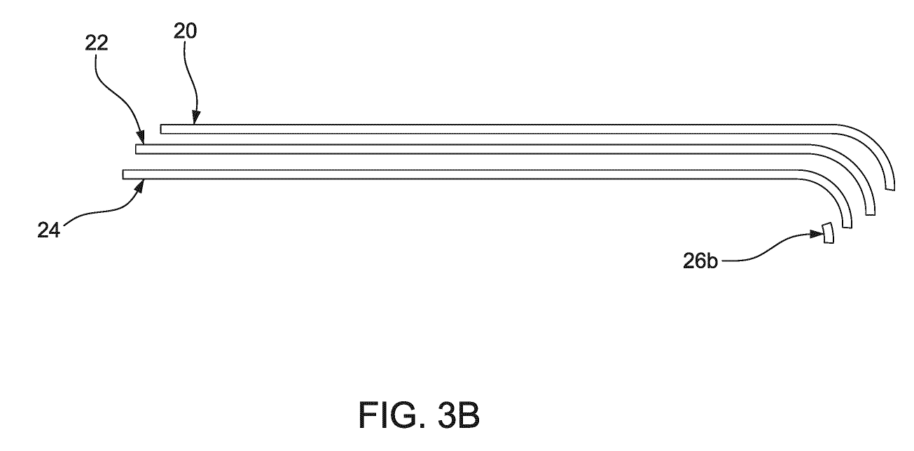

FIG. 3A and FIG. 3B are exploded views of parts of device 10 which illustrate the relative positions of certain components of screen 12 and the above-noted force sensors. As shown, screen 12 is a touch sensitive screen formed by three adjoining layers: cover 20, touch sensor 22, and display 24. Each layer is curved at its sides to extend over sides 14a and 14b (FIG. 1).

Cover 20 may be formed of glass, plastic, or another material that is suitably durable and transparent. Touch sensor 22 may be a capacitive touch sensor, a resistive touch sensor, or another type of sensor suitable to detect a user's touch through cover 20. Touch sensor 22 is configured to detect a user's touch, and in response, generates one or more signals indicating the location of the touch. Display 24 may be a LCD display, an OLED display, or the like.

As shown, two elongate force sensors 26a and 26b are provided next to display 24. Each of force sensors 26a and 26b may be shaped to fit against the inside surface of display 24. Each of force sensors 26a and 26b senses forces applied to device 10 by a user, e.g., on cover 20 or a casing of device 10. So, each of force sensors 26a and 26b may sense forces transmitted through cover 20, touch sensor 22, and display 24. In an embodiment, each of the force sensors may be configured to be sensitive to forces in the range of 0-100 N.

Each of force sensors 26a and 26b may also sense forces applied by a user to a case or holster. Conveniently, this allows a user to provide pressure input by way of the force sensors without removing electronic device 10 from the case or holster.

Each of force sensors 26a and 26b is configured to detect forces applied by a user, and in response, generates one or more signals indicating at least one location of the forces and at least one magnitude of the forces. As detailed below, these signals may be used to form a force map, describing the magnitude of forces applied by the user at a plurality of locations along the length of the sensor. As detailed below, these signals may be processed by device 10 to determine a user input.

In an embodiment, each of the force sensors 26a and 26b can include an array of discrete force sensing elements which are spatially distributed along the corresponding one of the force sensors 26a and 26b. For instance, each array of discrete force sensors may have rows and/or columns of discrete force sensing elements such that each discrete force sensing element can be associated with a specific location of the corresponding one of the force sensors 26a and 26b. Each of the discrete force sensing elements can have a specific address associated with a known location on the external surface of the electronic device 10. In this embodiment, each of the discrete force sensing elements of the array may have a length and/or a width of about a fraction of a centimeter, for instance. In one specific embodiment, each of the force sensors 26a and 26b can be embodied in the form of an array of conventional piezo-resistive force sensors, each sensing force in an area of approximately 2-5 mm². Such conventional piezo-resistive force sensor may be able to sense force of 0.1 to 50 N, which typically corresponds to the upper range of human grip strength. An example of the conventional piezo-resistive force sensor may be of model FLX-A101-A marketed by Tekscan. In another specific embodiment, each of force sensors 26a and 26b may be a sensor substantially similar to a sensor described in Kim, Hong-Ki, et al. “Transparent and flexible tactile sensor for multi touch screen application with force sensing.” Solid-State Sensors, Actuators and Microsystems Conference, 2009. TRANSDUCERS 2009. International. IEEE, 2009, the entire contents of which are hereby incorporated by reference. In another specific embodiment, each of force sensors 26a and 26b may be a piezo-resistive multi-touch sensor, provided by Motorola Solutions, Inc. (Illinois, USA).

As shown in FIG. 3A, each of force sensors 26a and 26b spans the length of screen 12. However, in another embodiment, force sensors 26a and 26b may span a part (or parts) of screen 12. As will be appreciated, only parts of the sides 14a and 14b corresponding to the span of force sensors 26a and 26b will be pressure sensitive. In an embodiment, force sensors 26a and 26b may be disposed along other surfaces of device 10 (e.g., its top, bottom, or front display surface) to provide pressure-sensitivity to such other surfaces. In an embodiment, force sensors may be disposed along each of sides 14a, 14b, and such other surfaces.

In some embodiments, at least one of force sensors 26a and 26b may be formed of flexible materials, allowing the sensors to be readily shaped and fitted to the interior of device 10, e.g., against a curved surface of display 24.

In some embodiments, at least one of force sensors 26a and 26b may be formed of transparent materials. In such embodiments, at least one of force sensors 26a and 26b may be disposed as a transparent layer over display 24. So, this layer may cover at least part of display 24, but allow the covered part of display 24 to be viewed therethough.

In some embodiments, at least one of force sensors 26a and 26b may be replaced by an array of force sensors. For example, such an array may be disposed along an edge of device 10, and each element in the array may detect force(s) at a particular point or in a particular region. Such an array of force sensors may cooperate to provide the above-noted signals for forming a force map.

In some embodiments, force sensors 26a and 26b may be replaced by a single sensor, e.g., a sensor spanning multiple edges of device 10.

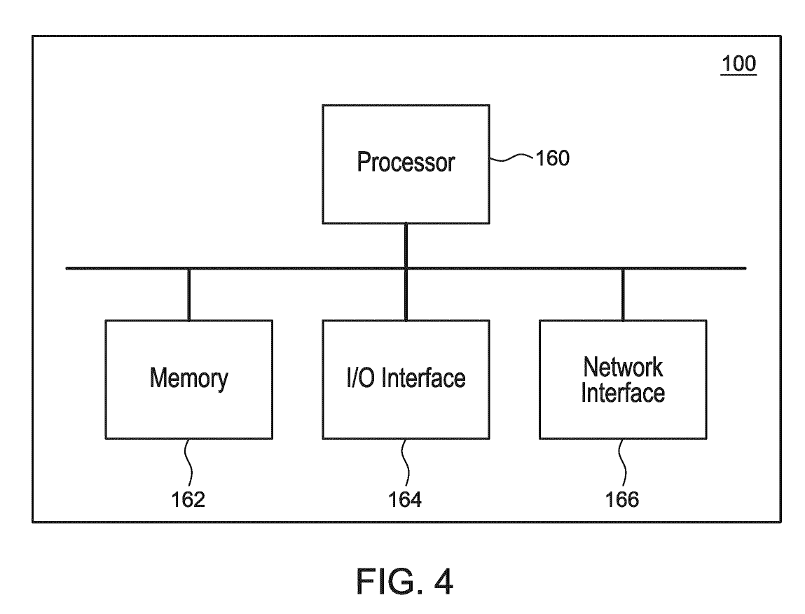

FIG. 4 schematically illustrates computer components of electronic device 10, exemplary of an embodiment. As shown, device 10 may include at least one processor 160, memory 162, at least one I/O interface 164, and at least one network interface 166.

Processor 160 may be any type of processor, such as, for example, any type of general-purpose microprocessor or microcontroller (e.g., an ARM™, Intel™ x86, PowerPC™processor, or the like), a digital signal processing (DSP) processor, an integrated circuit, a field-programmable gate array (FPGA), or any combination thereof.

Memory 162 may include a suitable combination of any type of electronic memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

I/O interface 164 enables device 10 to communicate with peripherals (e.g., keyboard, speakers, microphone, etc.) and other electronic devices (e.g., another device 10). I/O interface 164 may facilitate communication according to various protocols, e.g., USB, Bluetooth, or the like.

Network interface 166 enables device 100 to communicate with other devices by way of a network. Network interface 166 may facilitate communication by way of various wired and wireless links.

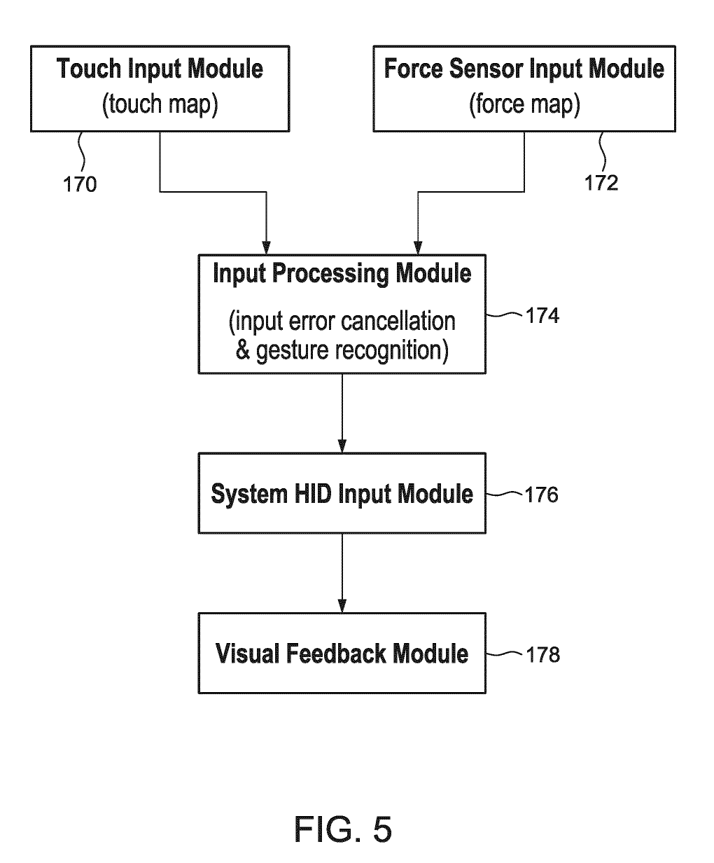

FIG. 5 schematically illustrates software components of electronic device 10 configured to process signals from one or more of touch sensor 22 and force sensors 26a and 26b, and to respond to such signals. Each of these software components may be implemented using a conventional programming language such as C, C++, Objective-C, Java, or the like.

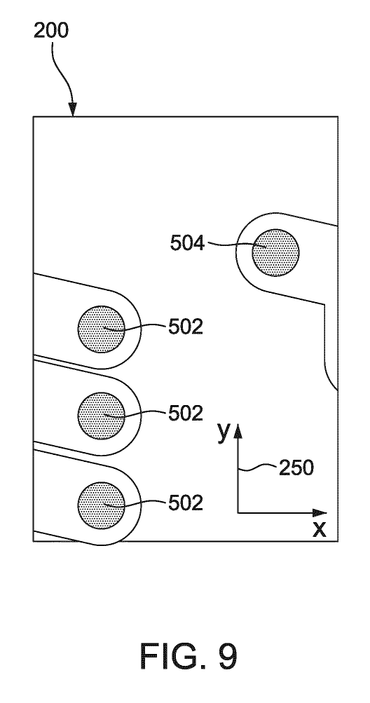

Touch input module 170 receives signals from touch sensor 22 indicating one or more locations of a user's touch on screen 12. Each location may, for example, correspond to a location of one finger of the user on screen 12. Touch input module 170 may filter received signals (e.g., to de-noise). Touch input module 170 processes these signals to generate a touch map (FIG. 9) indicating location of each touch. Touch input module 170 provides touch maps to input processing module 174.

Force sensor input module 172 receives signals from force sensors 26a and 26b indicating at least one sensed magnitude of a force applied by a user. The signals may indicate a plurality of magnitudes of forces applied by the user, with each of the magnitudes associated with a particular location of the forces. Force sensor input module 172 may filter received signals (e.g., to de-noise).

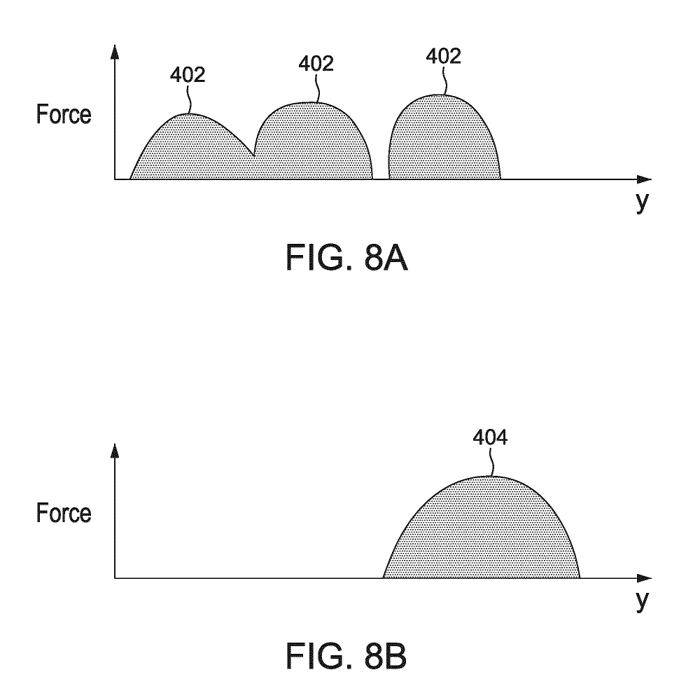

Force sensor input module 172 processes these signals to generate, for each of force sensors 26a and 26b, a force map (FIG. 8A and FIG. 8B) indicating the locations and magnitudes of sensed forces. Force sensor input module 172 provides force maps to input processing module 174.

Input processing module 174 receives touch maps and force maps and processes them to determine a user input. For example, input processing module 174 may determine that a touch map corresponds to a finger touch at a particular location on screen 12. This user input may be provided to system HID input module 176, which may respond to the finger touch, for example, by launching an application having an icon displayed at the pressed location.

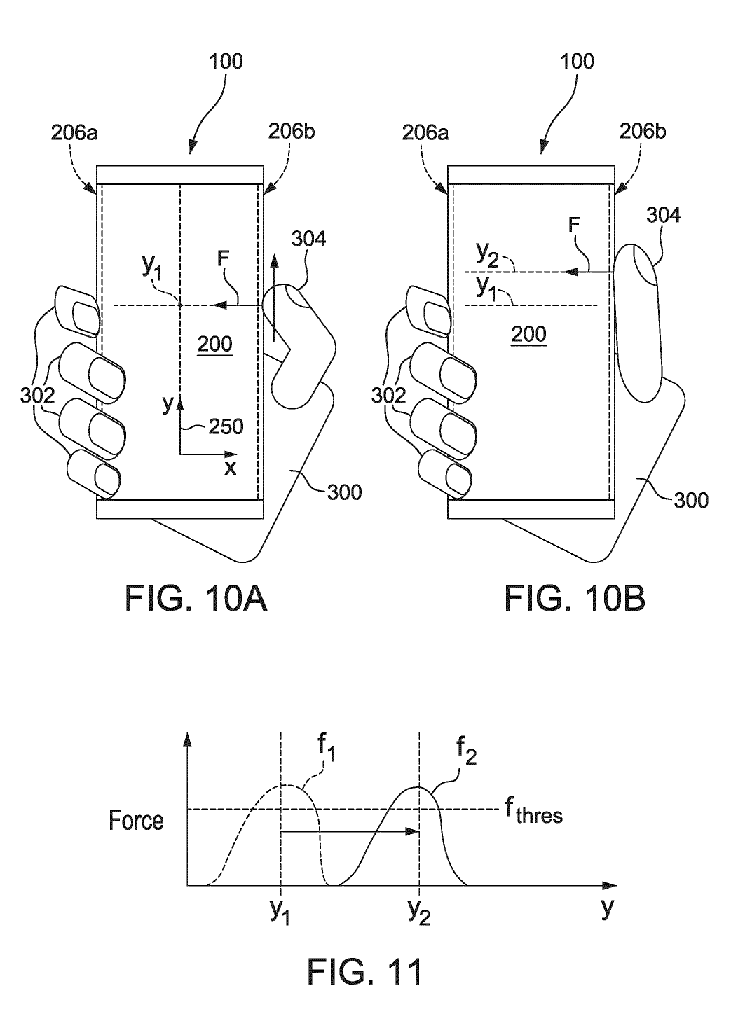

Similarly, input processing module 174 may determine that a force map for force sensor 26a indicate that a user pressed a particular location on side 14a of device 10. This user input may be provided to system HID input module 176, which may respond to the press, for example, by scrolling a displayed panel, if the particular location on side 14a has been defined to be associated with a scroll function (i.e., that location has been defined as scroll button). The magnitude of the force associated with the press may be taken into account. For example, a greater force may cause the scrolling to be faster. Such a scroll gesture is further described below with reference to FIG. 10A and FIG. 10B.

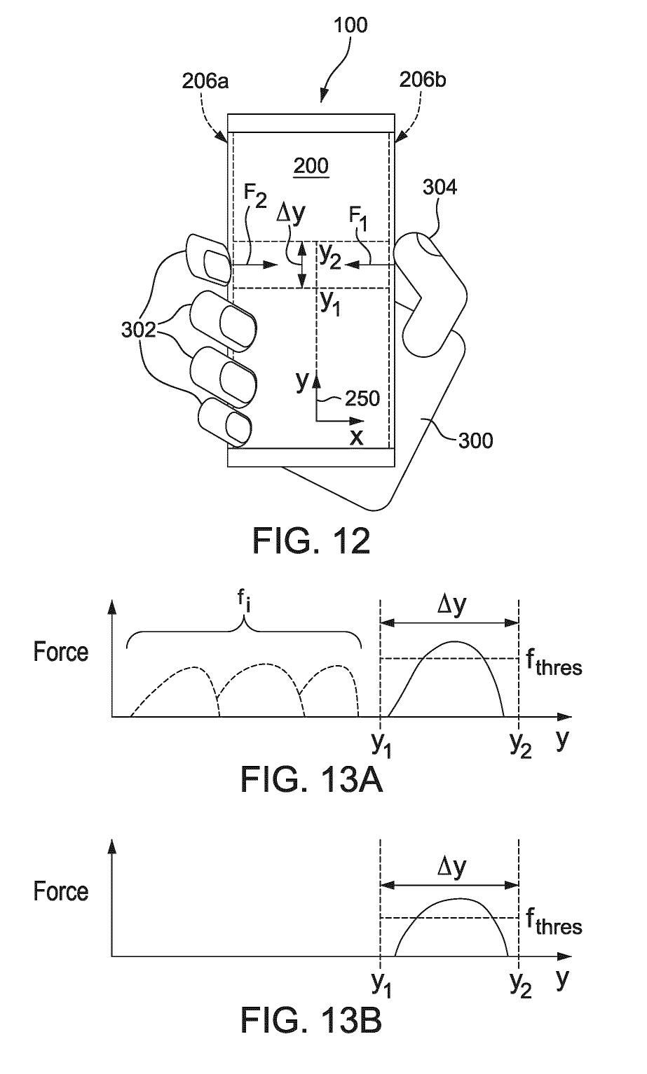

Input processing module 174 may take into account force maps from both of force sensors 26a and 26b. For example, input processing module 174 may determine that the force maps correspond to a user pinching (e.g., using a finger and a thumb) sides 14a and 14b at particular locations on sides 14a and 14b. This user input may be provided to system HID input module 176, which may respond to the pinching, for example, by activating a camera (not shown) of device 10, if the pinched locations have been defined to be associated with a camera function. Such pinch gesture is further described below with reference to FIG. 12.

By way of another example, input processing module 174 may determine that the force maps correspond to a user applying a full-handed grip (e.g., using all fingers and thumb) sides 14a and 14b. This user input may be provided to system HID input module 176, which may respond to the grip, for example, by waking up device 10, if a full-hand grip has been defined to be associated with a wake-up function. In this example, the particular locations of the forces may be used simply to identify the presence of four fingers and a thumb, associated with gripping, and the locations of each finger/thumb may be ignored.

In some embodiments, input processing module 174 may store a sequence of touch maps and/or force maps over a period of time (e.g., a few seconds, or for the duration that a user is providing continuous touch input or pressure input). Input processing module 174 may process the sequence to match the sensor signals to a predefined gesture comprising a sequence of touch inputs and/or pressure inputs. Gestures may include solely touch inputs (e.g., a swipe of screen 12), solely pressure inputs (e.g., two quick pinches in quick succession, which may be referred to as a “double pinch”), or a combination of touch inputs and pressure inputs.

Gestures that include solely pressure inputs may be referred to as “grip gestures”. Grip gestures may be based on locations and magnitudes of forces applied by a user over a period of time and changes in those locations and magnitudes over that period.

In this way, a user may issue complex gesture inputs corresponding to requests to launch particular applications, launch particular webpages, activate application functions, enter alphanumeric inputs, and so on.

According to one example, a user may launch an e-mail application, compose an e-mail, and send that e-mail, solely through grip gestures. As detailed below, this allows for one-handed operation of device 10.

According to another example, a user could authenticate his or her identity through a secret grip gesture, which may be user defined. This secret grip gesture may be inputted, for example, to unlock device 10 or to access particular application functions (e.g., to engage in a financial transaction). As will be appreciated, the magnitude of forces being exerted by a user is difficult to observe, and user authentication through grip gestures may be more secure than some conventional forms of user authentication (e.g., by typing a password).

According to another example, a grip gesture may allow a region associated with a particular function to be dynamically defined by processing one or more force maps. For example, input processing module 174 may process a force map to determine the location of one or more fingers of a user's hand along one edge of device 10. Based on the location of the fingers, input processing module 174 may predict the location of the thumb of that hand and define a region along the opposite edge of device 10 corresponding to the predicted thumb location. The region may then be associated with a particular function such that pressure input in the region, e.g., by the thumb, may be used to activate that function. For example, where the particular function is a scroll function, once the region has been defined, applying pressure with the thumb or, alternatively, moving the thumb up and down in the region may be used to activate scrolling.

Input processing module 174 allows user inputs to be reconfigured.

For example, particular regions of sides 14a and 14b may be initially configured to be associated with particular functions, which may correspond to functions of conventional mechanical inputs (e.g., power, volume, camera, etc.) However, associations between regions of sides 14a and 14b and functions may be reconfigured, e.g., by a user, or by applications executing at device 10. Such associations between regions and functions may be reconfigured to modify the regions (e.g., activate, deactivate, resize, relocate regions) or to change the associated functions (e.g., swapping power and camera functions).

Gestures, including touch and/or pressure inputs, may also be reconfigured such that a user may create, remove, activate, deactivate, and modify gestures. Input processing module 174 may allow gestures to be created by recording a sequence of user inputs.

Collectively, a set of associations between regions and functions, and a set of gestures may be referred to as an input configuration.

In an embodiment, input processing module 174 may provide a utility allowing a user to modify the input configuration, e.g., by way of a graphical user interface.

Different input configurations may be associated with different users of device 10 such that a particular configuration may be automatically selected when device 10 is being used by that user. Similarly, different input configurations may be associated with different applications such that a particular configuration may be automatically selected when that application is executed at device 10.

Input processing module 174 may apply conventional pattern recognition algorithms to force maps and touch maps to recognize particular inputs (e.g., pinching, gripping), touch gestures, force gestures, and gestures that include both touch and force components. Pattern recognition algorithms may be used in conjunction with pattern definitions or templates as may be associated with particular user inputs and gestures, and stored in memory 162.

Upon processing touch maps and force maps, force sensor input module 172 may cause certain sensor signals to be ignored. For example, if all of the force signals for the force maps are below a predefined threshold, the signals may be ignored. In this way, force signals associated with mere holding of device 10 may be ignored. In some embodiments, separate thresholds may be defined for particular regions of device 10, associated with particular forces in those regions resulting from mere holding of device 10. In some embodiments, one or more of the predefined thresholds may be adjusted depending on how device 10 is being used (e.g., as a phone or as a camera, with one hand or with two hands, etc.), and depending on the forces resulting from mere holding of device 10 for such uses. In some embodiments, one or more of the predefined thresholds may be adjusted for a particular user and depending on the forces associated with mere holding of device 10 by that particular user.

Force sensor input module 172 may also ignore sensor signals that do not match a recognized user input or gesture.

System HID input module 176 receives the user input determined by input processing module 174 and responds to the user input by invoking a function associated with the user input (e.g., activating a camera, launching an application, changing device volume, etc.). System HID input module 176 may also provide the user input to an operating system or a particular application executing at device 10 for response.

Visual feedback module 178 displays visual cues on screen 12 to indicate to a user those regions of sides 14a and 14b configured to be responsive to pressure input and functions configured for those regions. For example, visual feedback module 178 may display a camera icon in association with a region configured for activation of a camera of device 10.

Providing such visual cues helps the user to adapt to changing input configurations and allows users to locate regions of 14a and 14b that are responsive to pressure input.

Visual feedback module 178 may also display visual cues on screen 12 to indicate when pressure input has been received. For example, visual feedback module 178 may change the colour of the camera icon when a press is detected in the associated region.

In the depicted embodiment, as screen 12 extends onto each of sides 14a and 14b, visual cues may be displayed to overlay the associated regions of sides 14a and 14b. In other embodiments, e.g., when screen 12 is flat and does not extend onto sides 14a and 14b, visual indicators may be displayed proximate (e.g., adjacent) the associated regions sides 14a and 14b.

In an embodiment, the visual cues indicating regions responsive to pressure input may be selectively displayed in response to user input. For example, the visual cues may be initially hidden and displayed in response to a first press along any part of a side 14a or 14b. Visual cues may become hidden again after a predefined period of time. The user may then apply a second press at the indicated location to access the desired function.

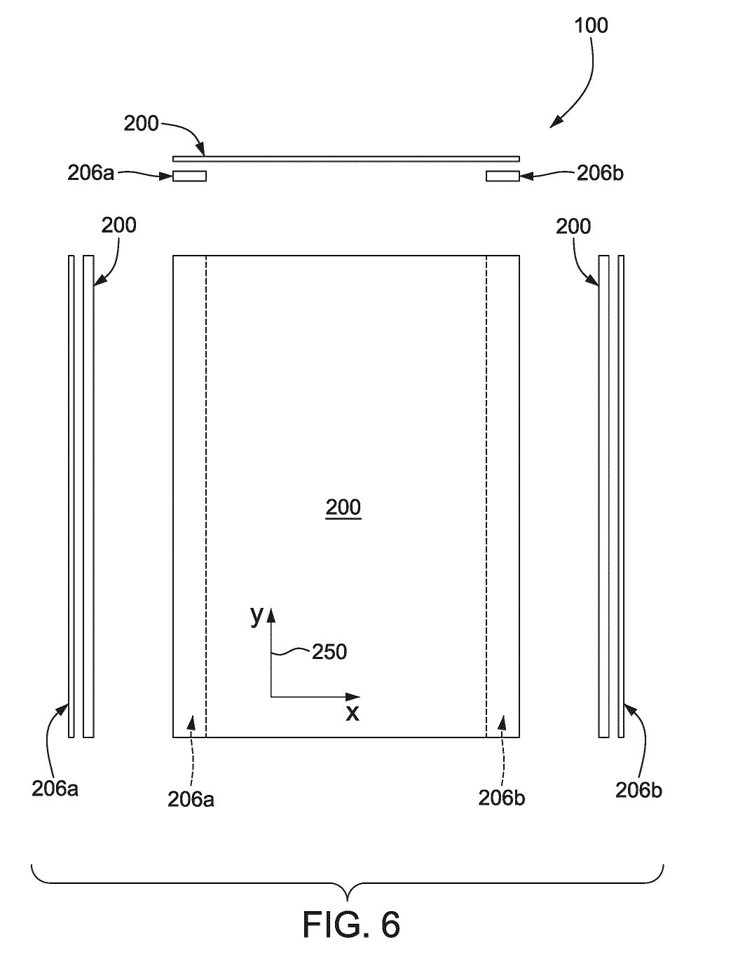

FIG. 6 schematically illustrates mapping of signals from touch sensor 22 and force sensors 26a and 26b to locations on device 10. As shown, signals from touch sensor 22 are mapped to locations in region 200, signals from force sensor 26a are mapped to locations in region 206a, and signals from force sensor 26b are mapped in locations in region 260b. As shown, region 200 overlaps with both of regions 206a and 206b, reflecting the overlap between touch-sensitive screen 12 and each of sides 26a and 26b. The region 200 and any of the regions 206a and 206b can alternately not overlap in another embodiment.

A coordinate system 250 may be defined for regions 200, 206a, and 206b, allowing locations of sensed touches and forces to be expressed with reference to this coordinate system in the above-noted touch maps and force maps. In particular, each touch input may be expressed as an x, y coordinate within coordinate system 250, and each pressure input may be expressed as a scalar value along the y-axis within coordinate system 250.

In an embodiment, coordinate system 250 may be a pixel coordinate system of display 24.

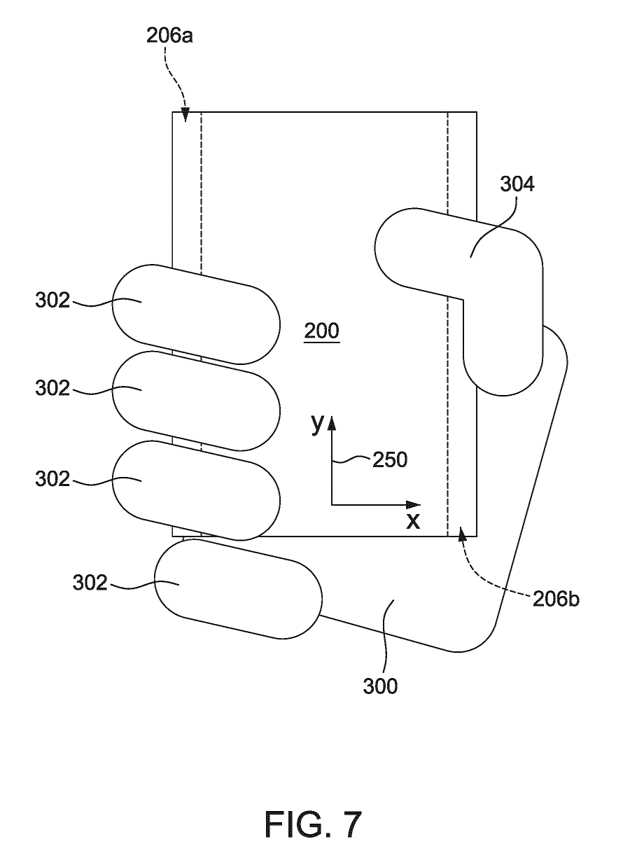

FIG. 7, FIG. 8A, FIG. 8B and FIG. 9, schematically illustrate an example mapping of sensor signals to regions 200, 206a, and 206b when device 10 is gripped in a user's hand.

In particular, as shown in FIG. 7, device 10 may be gripped by a hand 300 having fingers 302 and thumb 304.

FIG. 8A shows a force map of forces sensed by force sensor 26a in region 206a, while FIG. 8B shows a force map of forces sensed by force sensor 26b in region 206b. As shown, the force map for region 206a includes forces 402 at locations and magnitudes corresponding to pressure applied by each of fingers 302. Meanwhile, the force map for region 206b includes forces 404 at locations and magnitudes corresponding to pressure applied by thumb 304.

FIG. 9 shows a touch map of touches sensed by touch sensor 22 in region 200. As shown, the touch map includes touches at locations 502 and 504 corresponding to each of fingers 302 and thumb 304 touching screen 12.

A conventional touch-screen device typically requires two hands for operation: one hand to hold the device, and another hand to provide touch input. Conveniently, embodiments of electronic device 10 may be readily operated using a single hand. In particular, a single hand may be used both to hold device 10 and to provide input in manners described above, e.g., using one-handed grip gestures to initiate wake-up of the device, unlock the device, input text, launch applications or websites, etc.

Device 10 may be operated by using pressure inputs such as button layouts and gestures to the sides 14a and 14b from a single hand such that no region of display 24 is obstructed by a second hand. Providing convenient one-handed operation may improve the ability of the user to multitask. Providing convenient one-handed operation may also improve ergonomics and/or input efficiency.

In an embodiment, the device 100 typically receives a force applied on the external surface of the device 100 which causes the processor 160 to receive a signal indicative of the force applied on the device 100. The processor 160 can then determine the user input based on the signal received. After determining the user input, the processor 160 may process predetermined functions associated with the user input. As examples of such user inputs have been described above, the following paragraphs describe in further detail some exemplary gestures.

FIG. 10A and FIG. 10B show steps of an exemplary gesture, which will be referred to as the “scroll gesture”, in accordance with an embodiment. For simplicity and ease of reading, reference to locations of the device 100 will be made using the coordinate system 250. As illustrated, the scroll gesture includes a first step of applying a force F (e.g., using the thumb 304) to a first location y1 of the region 206b and a step of sliding the force F along the side of the device 100 towards a second location y2. In other words, the force F is successively applied to a plurality of locations along the edge of the device 100 (i.e. along the y-axis of coordinate system 250). FIG. 11 shows a signal having a first magnitude f1 indicative of the force being applied to the first location y1 of the region 206b and received by the processor 160 at a given temporal coordinate. The signal also has a second magnitude f2 indicative of the force when slid towards the second location y2 of the region 206b and received by the processor 160 at a subsequent temporal coordinate. In this embodiment, when the processor 160 receives the signal, it may determine that the user input is a scroll gesture input and process a predetermined function (e.g., moving content in a displayed panel). The predetermined function may be dependent upon the magnitude of the signal received. Indeed, as mentioned above a greater force may cause the scrolling to be faster. In another embodiment, the scroll gesture is determined when the force reaches a force threshold_{fthres}, as shown in FIG. 11, which helps avoid “false positives”. In other words, the user has to applya force which has a magnitude at least equal to the force threshold fₜₕᵣₑₛ or greater to the force threshold fₜₕᵣₑₛ for any scroll gesture to be determined by the processor 160. In alternate embodiments, the scroll gesture may be performed along a front face, a back face and/or along the other side of the device 100. In another embodiment, the signal 1100 may have more than two magnitudes associated with more than two locations along the y-axis of coordinate system 250. It is understood that although the force F is shown to have a constant magnitude from location y1 to location y2, the magnitude of the force F may alternately vary between the locations y1 and y2.

Before describing any other gesture, it is noted that while setting a standard force threshold may be satisfactory for many applications, the force threshold fₜₕᵣₑₛ can be customized, and the customization can even be specific to individual or groups of gestures. A gesture input may be determined by the processor 160 only when the magnitude of the force applied by the user to the side of the device 10 is equal or greater than the threshold fₜₕᵣₑₛ corresponding to the corresponding gesture. It is envisaged that the force threshold fₜₕᵣₑₛ may depend on the type of gesture performed by the user, and also that the force threshold fₜₕᵣₑₛ may have a single force threshold value associated to a given location of one of the force sensors 26a and 26b, but the force threshold fₜₕᵣₑₛ may have an array of force threshold values associated with a multitude of locations along one of the force sensors 26a and 26b. As such, when performing a scroll gesture, the processor 160 may determine a scroll gesture input only when the magnitude of the force applied to the device 10 and slid therealong is sufficient (equal or greater than a corresponding of the force threshold values) along the entirety of a given portion of the side of the device 10. In an embodiment, the user may be allowed to associate a user-defined force magnitude to the force threshold fₜₕᵣₑₛ in association with a given gesture. For instance, a user may prefer to modify the default force threshold fₜₕᵣₑₛ associated with a given gesture. Such modification of the default force threshold fₜₕᵣₑₛ may be preferred when normal use of the electronic device 10 cause the processor 160 to erroneously determine the given gesture. In this embodiment, the user may activate a force threshold modification application stored on the electronic device 10 and modify the force magnitude of the force threshold fₜₕᵣₑₛ associated with the given gesture based on his/her personal preferences. For instance, the force threshold modification application may have a progress bar which indicates, in real-time, the magnitude of the force being applied at a given location on the side of the electronic device 10 so that the user can visually set a user-defined force magnitude to the force threshold for the given gesture. In another embodiment, the force threshold fₜₕᵣₑₛ can be modified otherwise. A lower force threshold can be preset, or user defined, for people having smaller hands.

FIG. 12 shows another exemplary gesture, which will be referred to as the “pinch gesture”, in accordance with an embodiment. Reference to the locations of the device 100 will be made using the coordinate system 250. As depicted, the pinch gesture includes steps of applying a first force F1 (e.g., using any of fingers 302) along region 206a while applying a second, opposite force F2 (e.g., using the thumb 304) along region 206b of the device 100. In the illustrated embodiment, the first and second forces F1 and F2 are applied within an interval Δy comprised between locations y1 and y2. It is noted that although interval Δy can span along a single one of the conventional force sensors of the array. In this embodiment, when the processor 160 receives the signal shown in FIGS. 13A-B it may determine that the user input is a pinch gesture input and process a predetermined function (e.g., activating a camera). In another embodiment, the pinch gesture is determined when the processor 160 receives signals representative of F1 and F2 which each has a magnitude that reaches a force threshold fₜₕᵣₑₛ, as shown in FIGS. 13A-B. In other words, the camera is deactivated unless a pinch gesture of a predetermined force is performed by the user, which helps to avoid “false positives”. It is understood that, in another embodiment, the pinch gesture can be triggered by opposing forces F1 and F2 which have different magnitudes. It is noted that when the processor 160 receives a signal which includes magnitudes fi, such as shown in FIG. 13A, corresponding to forces being applied along the region 206a by fingers 302 in addition to the pinch gesture, the processor 160 may determine that the user input is a grip gesture.

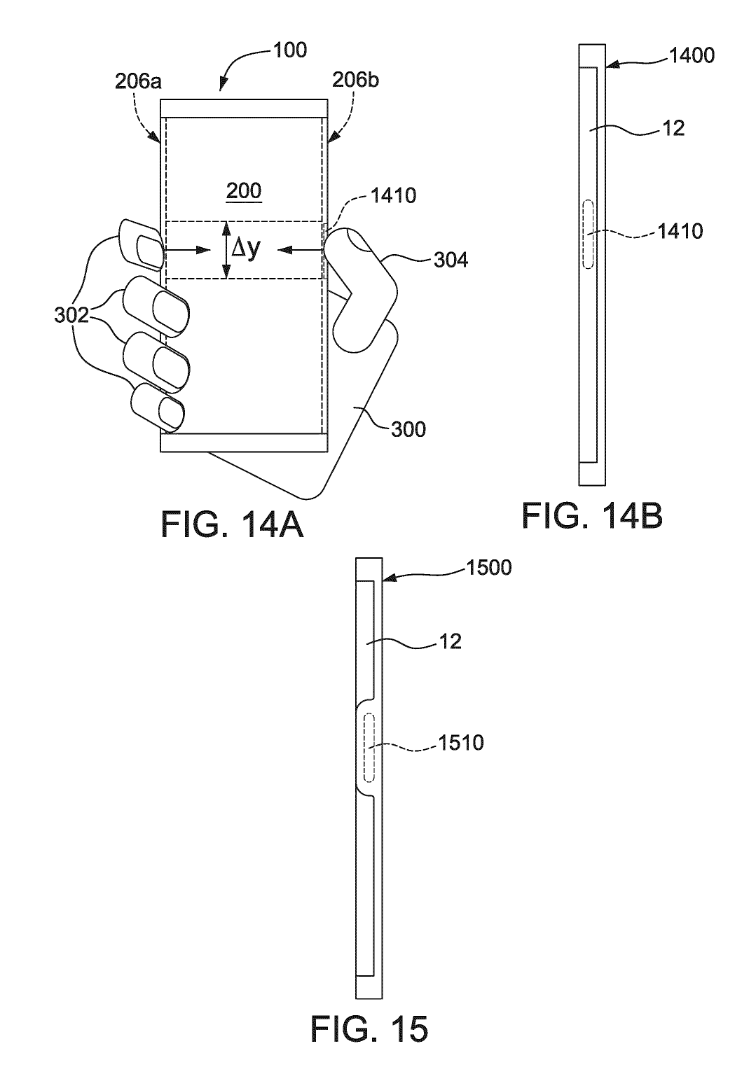

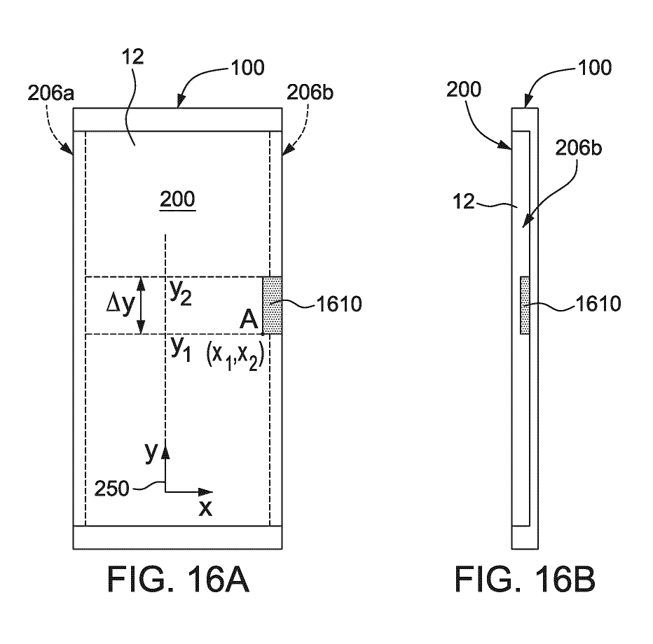

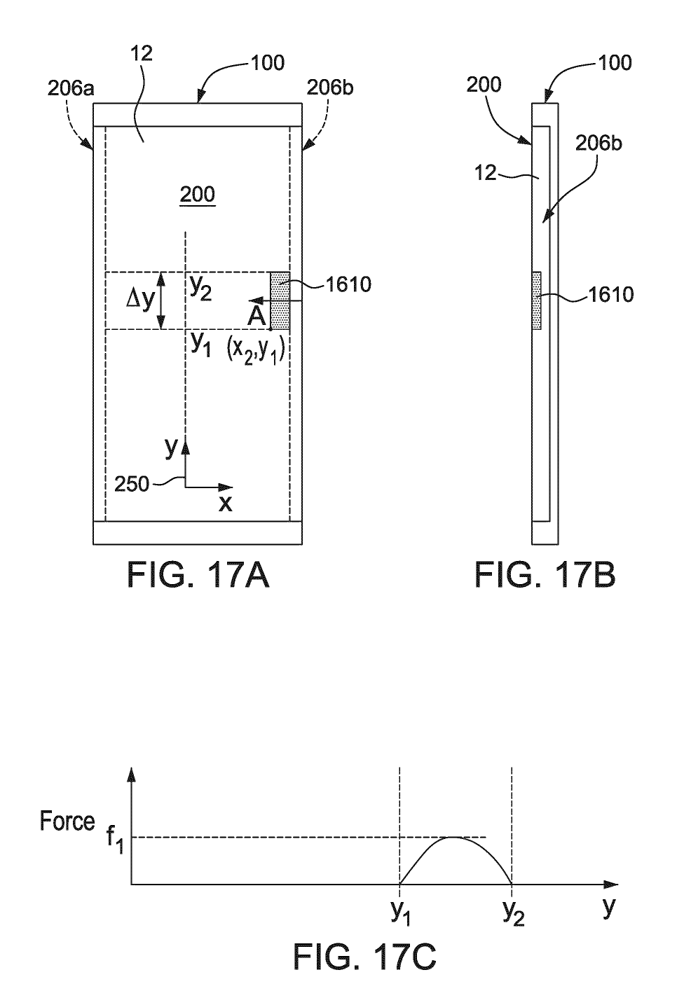

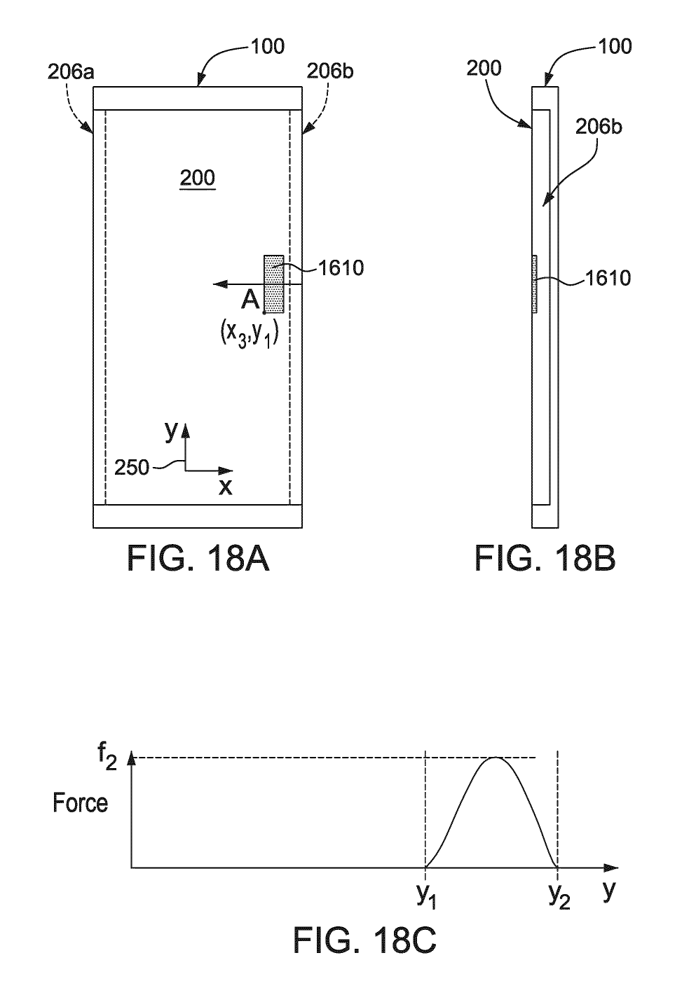

In an alternate embodiment, the electronic device may include a fingerprint sensor. As depicted in FIGS. 14A-15, the fingerprint sensors 1410 and 1510 may be disposed along a side of a corresponding one of electronic displays 1400 and 1500. In the embodiment shown in FIGS. 14A-B, the fingerprint sensor 1410 is incorporated into the screen 12 of the device 1400. In an alternate embodiment, the fingerprint sensor 1510 is disposed on the device 1500 but separate from the screen 12. Examples of the fingerprint sensors 1410 and 1510 are described in US 2015/0036065 and US 2015/0242675, respectively. Other types of fingerprint sensor may be used. For ease of reading, reference is now made solely to the embodiment shown in FIGS. 14A-B. In this embodiment, the fingerprint sensor 1410 may be activated upon determination, by the processor 160, of a pinch gesture data indicating that the user pinched the electronic device 1400 within the interval Δy. In another embodiment, the fingerprint sensor 1410 can be activated upon sensing a force on the side opposite the fingerprint sensor 1410. This may be helpful, for example, if there is no force sensor at the location of the fingerprint sensor 1410 such that the user can perform a “pinch gesture”, which is only sensed on one side and still activate the fingerprint sensor 1410. Such activation may include transmission, by the processor 160, of a signal to the fingerprint sensor 1510. The combined use of the fingerprint sensor 1410 and the force sensors may help in saving power and reducing unintended input to the fingerprint sensor (e.g., when the device is gripped during device operation). For instance, if the fingerprint sensor 1410 is used to unlock the device 1400, a single pinch gesture performed by the user can unlock the device 1400. As will be understood, although the fingerprint sensor is disposed on a front face of the device, the finger print sensor can alternately be disposed on front and back faces of the device. In some embodiments, such as the one shown in FIG. 16A, the electronic device 100 has screen 12 displaying user interface elements such as the one shown at 1610. Such user interface elements may be displayed in the form of buttons and/or menus depending on the circumstances. For ease of understanding, the exemplary user interface element 1610 is a button displayed along the region 206b, along one of the sides of the electronic device 100. In this embodiment, the location (x1, y1), where the user interface element 1610 is displayed, is modified in response to reception of the signal from the force sensor near region 206b. For instance, FIGS. 16A-B display the user interface element 1610 at a default location. When displayed at the default location, reference position A of the user interface element 1610 is displayed at a first location (x1, y1). Referring now to FIGS. 17A-C, the processor 160 may modify (e.g., move) the display of the user interface element 1610 upon reception of a force of magnitude f1. In this embodiment, when the processor 160 determines that the user input is a force applied to the side of the device 100 and within interval Δy of the screen 12, the processor 160 may modify the display of the user interface element. As shown, the modification includes a translational movement of the reference position A towards the second location (x2, y2). This modification of the display causes the user interface element 160 to be moved towards the region 206a. Referring to FIGS. 18A-C, the processor 160 may further modify the display of the user interface element 1610 upon reception of a signal having a magnitude f2, greater than the magnitude f1. When the magnitude f2 is reached, for instance, the reference position A may be moved further towards region 206a, away from region 206b. As it will be understood, other types of modification can be performed to the display of the user interface element 1610. Examples of such modification of the display may include removal of the display, replacement of the user interface element 1610 per another user interface element, rotational movement of the element 1610, showing the element 1610 in another configuration, and modifying the element 1610 to simulate a real-world response to a given force. It is understood that the simulation of the real-world response can be of any type. For instance, a button which is displayed to the side of the device 10 may be shown to be “depressed” upon receiving a signal indicative of a magnitude of a force to a location corresponding to that of the button. It is envisaged that the magnitude of the force can influence the corresponding real-world response such that a smaller magnitude can cause the button to be slightly depressed, and that a greater magnitude can cause the button to be fully depressed, for instance.

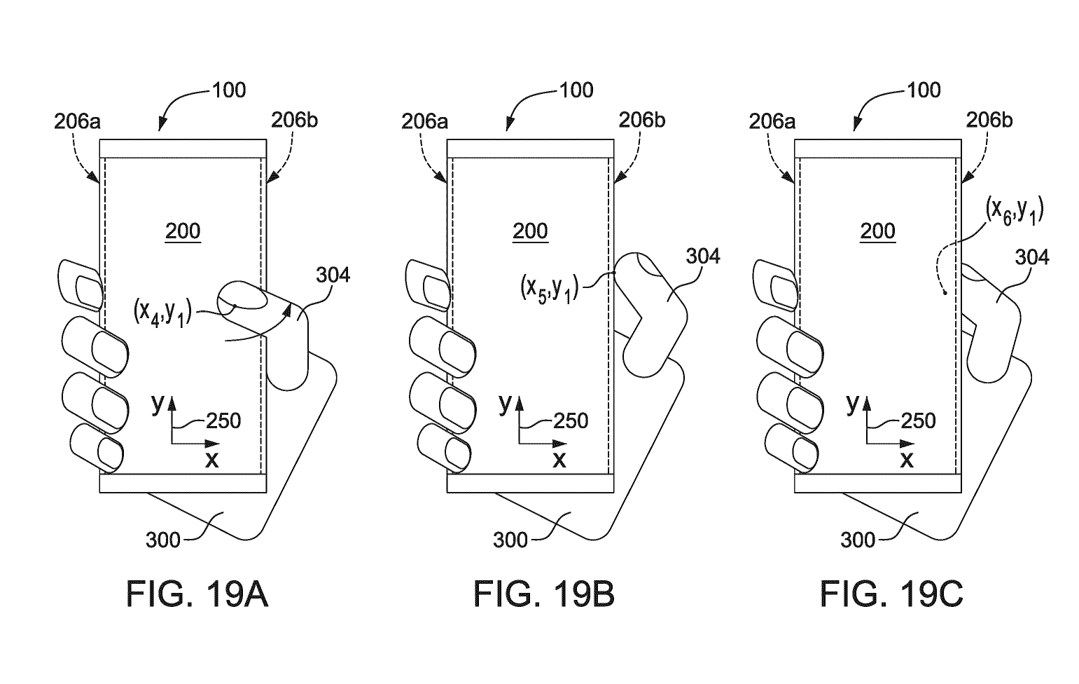

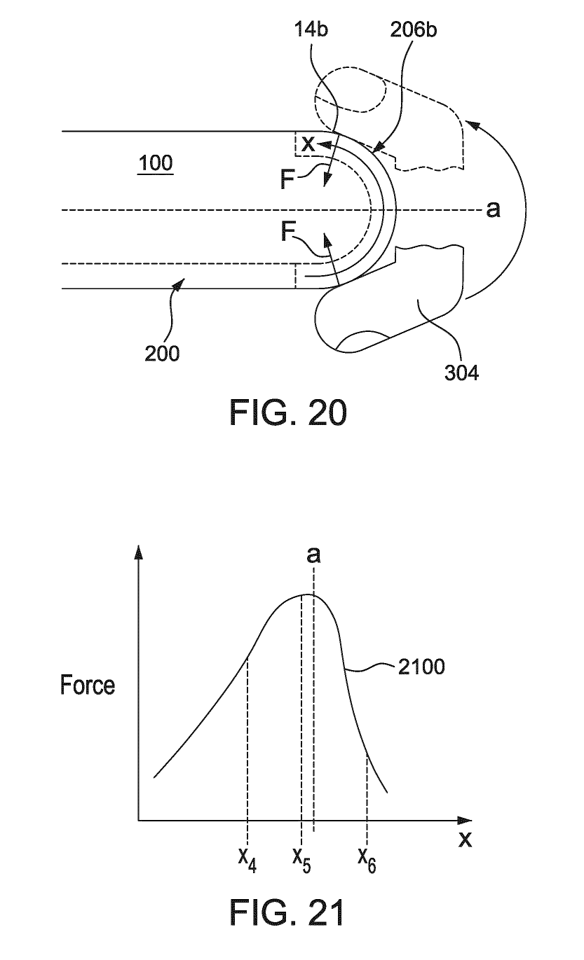

FIGS. 19A-C show another exemplary gesture, which will be referred to as the “flick gesture”, in accordance with an embodiment. Reference to the locations of the device 100 will be made using the coordinate system 250. As depicted in FIGS. 19A-C, the flick gesture includes steps of a first step of applying a force F (e.g., using the thumb 304) at location (x4, y1) and of sliding the force F across the side of the device 100 to reach location (x5, y1) and then location (x6, y1), for instance. FIG. 20 is a top plan view of the electronic device 100 which shows that the x-axis of coordinate system 250 is curvilinear when the region 206b is wrapped around at least part of the side 14b of the device 100. Accordingly, FIG. 21 shows an exemplary signal 2100 received by the processor 160 following a flick gesture along the x-axis as shown in FIGS. 19A-C. It is noted that in this embodiment, the magnitude of the force of signal 2100 is not constant over the section along the x-axis. Indeed, the magnitude of the force F may reach a maximal value at a location x5 upstream from midpoint of the side 14b of the device 100, as shown in FIG. 20. However, it will be understood that the signal indicative of a flick gesture may differ depending on the circumstances and that the flick gesture can be implemented on either edges 14a and 14b of the device 100.

In another embodiment, the processor 160 may be configured to perform a predetermined function upon determination of a user-defined signal which may have been previously programmed by the user of the electronic device 10. Indeed, in this embodiment, the electronic device 10 can have stored on its memory an application which allows saving and storing of one or more user-defined signals upon reception of a corresponding one or more user-defined gestures. The user-defined signal may have at least two magnitudes of at least two forces being applied, simultaneously or successively, to at least one of the sides of the electronic device 10. When the user-defined signal(s) is(are) saved on the memory of the electronic device 10, the processor 160 may compare each received signal to the user-defined signal(s) in order to determine a corresponding predetermined function that may be performed. In an embodiment, upon determination of a match between the received signal and any of the stored user-defined signals, the processor 160 can unlock at least some functions of the electronic device 10. For instance, determination of a match between the received signal and any of the stored user-defined signals may unlock the electronic device 10 to other inputs. Unlocking the electronic device 10 in such a manner has been found convenient since a user-define gesture (i.e. a sequence having at least two forces applied to the side of the electronic device 10) can be very stealthy and may be more difficult to discern by onlookers. In another embodiment, the processor 160 prompts the user to input the user-defined gesture by displaying an indication on the display screen. When the indication is displayed on the screen, the user is invited to perform the corresponding user-defined gesture which may unlock a predetermined function. In an embodiment, such a user-defined gesture may include a first force applied to one of the sides of the electronic device 10 and quickly followed by an opposing second force applied to the other one of the sides of the electronic device 10, but at a location offset along the y-axis of the electronic device 10. It is understood that such user-defined gesture may include a combination of two or more forces at any step or step of the sequence, for instance.

Further, as user inputs (e.g., button layouts, gestures) may be changed in software, device 10 may be readily toggled between right-handed operation and left-handed operation.

Embodiments of electronic device 10 disclosed herein may allow users to provide pressure input by way of pressure-sensitive surfaces such as sides 14a and 14b of device 10 (FIG. 1), in lieu of conventional mechanical inputs. So, some embodiments of electronic device 10 may include no mechanical inputs. Conveniently, this may reduce the number of parts in device 10, which may simplify manufacture and reduce costs. Further, mechanical wear borne by mechanical inputs may be avoided. Eliminating mechanical inputs may also allow some embodiments of electronic device 10 to be more readily weather-sealed and/or water-sealed.

Various example embodiments are described herein. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments described herein provide useful physical machines and more specifically configured computer hardware arrangements of computing devices, processors, memory, networks, for example. The embodiments described herein, for example, are directed to computer apparatuses and methods implemented by computers through the processing and transformation of electronic data signals.

Such hardware components are clearly essential elements of the embodiments described herein and they cannot be omitted or substituted for mental means without having a material effect on the operation and structure of the embodiments described herein. The hardware is essential to the embodiments described herein and is not merely used to perform steps expeditiously and in an efficient manner.

Although the disclosure has been described and illustrated in exemplary forms with a certain degree of particularity, it is noted that the description and illustrations have been made by way of example only. Numerous changes in the details of construction and combination and arrangement of parts and steps may be made. Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations and modifications are possible, and even advantageous, in various circumstances. The invention is intended to encompass all such variations and modification within its scope, as defined by the claims.

1. An electronic device comprising:
a body having a front face, a back face and sides;
a processor enclosed within the body;
at least one display disposed on at least one of the sides of the body and connected to the processor;
at least one touch sensing surface disposed on the at least one of the sides of the body and connected to the processor, the at least one touch sensing surface being operable to receive a touch applied to the at least one of the sides of the body and to generate at least one signal indicative of a location of the received touch on the at least one touch sensing surface; and
at least one force sensor disposed on the at least one of the sides of the body and connected to the processor, the force sensor being operable to generate at least one signal indicative of a magnitude of a force applied to the at least one of the sides of the body, the processor being configured to receive the at least one signal and to determine a user input by processing the received at least one signal;
the at least one display, the at least one touch sensing surface and the at least one force sensor overlapping with one another along a corresponding surface of the at least one of the sides of the body.

2. The electronic device of claim 1, wherein the at least one force sensor extends along a given surface of the at least one of the sides of the body and is operable to further generate at least one signal indicative of a location of the force applied to the at least one of the sides of the body and on the given surface of the body.

3. The electronic device of claim 1, wherein the at least one touch sensing surface, the at least one force sensor and the at least one display are disposed along at least part of each of two opposing sides of the sides of the electronic device.

4-5. (canceled)

6. The electronic device of claim 1, wherein the at least one touch sensing surface covers the at least one force sensor of the electronic device.

7. The electronic device of claim 1, further comprising a touch-sensitive screen that comprises the at least one display and the at least one touch sensing surface.

8. The electronic device of claim 1, wherein said determining the user input comprises processing the at least one signal received from the at least one force sensor and the at least one signal received from the at least one touch sensor.

9. The electronic device of claim 1, wherein the processor is configured to receive, from the at least one force sensor, at least one signal indicative of a plurality of magnitudes of forces applied on the at least one of the sides of the body, each of the magnitudes associated with one of a plurality of locations of the forces.

10. The electronic device of claim 3, wherein the at least one display and the at least one touch sensing surface extend between the two opposing sides of the sides of the electronic device over the front face of the body.

11. The electronic device of claim 10, wherein the at least one display is configured to present a visual indicator in response to receiving the at least one signal.

12. The electronic device of claim 11, wherein the visual indicator is displayed proximate the location of the force applied to the at least one of the sides of the body.

13. The electronic device of claim 1, wherein the electronic device is a hand-held electronic device.

14. The electronic device of claim 13, wherein the electronic device is one of a mobile phone, a tablet computer, a laptop computer, a personal digital assistant, a camera, an e-book reader and a game controller.

15-34. (canceled)

35. The electronic device of claim 1 wherein the at least one of the sides of the body is curved, the at least one display, the at least one touch sensing surface and the at least one force sensor being curved to extend over the at least one of the sides of the body.

36. The electronic device of claim 35 wherein the at least one force sensor is formed of flexible materials, the at least one force sensor being shaped to fit against an interior surface of the at least one display.

37. The electronic device of claim 1 wherein the at least one touch sensing surface is disposed over the at least one display, and the at least one force sensor is disposed underneath the at least one display.

38. The electronic device of claim 1 wherein the at least one force sensor is formed of transparent materials, the at least one force sensor being disposed over the at least one display.
